(19) United States
(12) Patent Application Publication
(10) Pub. No.: US 2005/0147874 A1
(43) Pub. Date: Jul. 7, 2005

(54) Venting system for battery

(75) Inventors: Glenn W. Andersen, Hartford, WI (US); Jerome R. Heiman, Campbellsport, WI (US); Gerald A. Cummins, Union, KY (US)

Correspondence Address: FOLEY & LARDNER, 777 EAST WISCONSIN AVENUE, SUITE 3800, MILWAUKEE, WI, 53202-5308, US

(73) Assignee: Johnson Controls Technolgy Company

(21) Appl. No.: 11/010,193

(22) Filed: Dec. 10, 2004

Related U.S. Application Data
(60) Provisional application No. 60/528,527, filed on Dec. 10, 2003.

(51) Int. Cl. H01M 2/12; H01M 2/04

(52) U.S. Cl. 429/87; 429/86; 429/175

(57) ABSTRACT

A venting system for a battery having a plurality of cells that includes a member configured for gas communication with a plurality of the cells. The member includes a plurality of vent barrels. At least one of the vent barrels includes a first aperture and a second aperture. The first aperture is configured to provide an opening through which gas may enter the member, and the second aperture is configured to provide an opening through which gas may exit the member.

### CROSS-REFERENCE TO RELATED APPLICATIONS

The present application claims the benefit under 35 U.S.C. § 119(e) of (and also expressly incorporates by reference herein in its entirety) the following related application: U.S. Provisional Patent Application No. 60/528,527 filed Dec. 10, 2003.

### BACKGROUND

The present invention relates to covers and vents for batteries (e.g., lead-acid batteries for use with vehicles or other applications, including starting, lighting, and ignition batteries; commercial batteries; industrial batteries; marine batteries; etc.).

Such batteries generally include a number of cells disposed in a battery housing. Each cell includes a plurality of positive and negative battery plates or electrodes. Separators are provided between the electrodes to prevent shorting and undesirable electron flow produced during the reaction occurring in the battery. The electrodes and separators are immersed in a liquid electrolyte in the cell (e.g., aqueous sulfuric acid). The positive plate generally is constructed of a lead-alloy grid covered with lead dioxide, while the negative plate generally contains lead as the active material, again covering a lead-alloy grid.

A cover is provided for the housing (e.g., coupled to the housing by a heat sealing operation, etc.). The cover includes terminals or bushings and a plurality of fill tubes to allow electrolyte to be added to the cells and to permit servicing, if required, during the life of the battery. To prevent undesirable spillage of electrolyte from the fill tubes, and to permit exhausting of gases generated during the electrochemical reaction, batteries have previously utilized filler hole caps and/or vent cap assemblies.

Gases generated during the electrochemical reactions which take place in the battery need to be expelled or exhausted from the battery to prevent undesirable gas buildup in the battery. Such reactions start at the time the battery is first charged (called “formation”) and also during normal operation of the battery. Factors such as high current charge and discharge conditions and changes in temperature can affect the rate at which gas evolution occurs.

While it is known to provide venting systems for batteries, such known venting systems do not provide certain advantageous features and/or combinations of features. Accordingly, there is a need to provide an improved venting system for a battery.

### SUMMARY

The present invention relates to a venting system for a battery having a plurality of cells that includes a member configured for gas communication with a plurality of the cells. The member includes a plurality of vent barrels. At least one of the vent barrels includes a first aperture and a second aperture. The first aperture is configured to provide an opening through which gas may enter the member, and the second aperture is configured to provide an opening through which gas may exit the member.

The present invention also relates to a lead-acid battery having a plurality of cells provided in a container that includes a cover coupled to the container and at least one gang vent coupled to the cover and in gas communication with a plurality of the cells. A plurality of vent barrels extend from the at least one gang vent. At least one of the vent barrels includes an inlet configured to provide a path for gas to travel from at least one cell of the battery into the gang vent and an outlet configured to provide a path for gas to be expelled from the gang vent.

The present invention also relates to a cover for a lead-acid battery that includes a plurality of gang vents. Each of the plurality of gang vents is configured for gas communication with a plurality of cells of a battery. Each of the plurality of gang vents is provided in gas communication with at least one other gang vent. The cover also includes an exhaust port that is in gas communication with at least one of the gang vents to allow gas to escape from the gang vents. At least one of the gang vents includes at least one vent barrel that includes both an inlet for allowing gas to enter the at least one gang vent from a battery cell and an outlet for allowing gas to escape the at least one gang vent through the exhaust port.

### BRIEF DESCRIPTION OF THE DRAWINGS

FIG. 1 is a perspective view of a battery including a cover having a venting system according to an exemplary embodiment.

FIG. 2 is an exploded perspective view of the battery and cover shown in FIG. 1.

FIG. 3 is a perspective view of the battery cover shown in FIG. 1.

FIG. 4 is a partial cutaway view of the cover shown in FIG. 1.

FIG. 5 is an enlarged view of a portion of the partial cutaway view of the cover shown in FIG. 1.

FIG. 6 is a perspective view of an element or member in the form of a gang vent according to an exemplary embodiment.

FIG. 7 is a perspective view of a bottom portion or component of the gang vent shown in FIG. 6.

FIG. 8 is another perspective view of the bottom portion or component of the gang vent shown in FIG. 6.

FIG. 9 is a perspective view of a top portion or component of the gang vent shown in FIG. 7.

FIG. 10 is a cross-sectional view of a portion of the venting system shown in FIG. 1.

FIG. 11 is a perspective view of portion of a bottom portion or component of a gang vent according to an exemplary embodiment.

FIG. 12 is a perspective view of the bottom portion or component of the gang vent shown in FIG. 11 showing the provision of a member or element in the form of a valve.

FIG. 13 is a cross-sectional view of a venting system according to another exemplary embodiment.

### DETAILED DESCRIPTION OF EXEMPLARY EMBODIMENTS

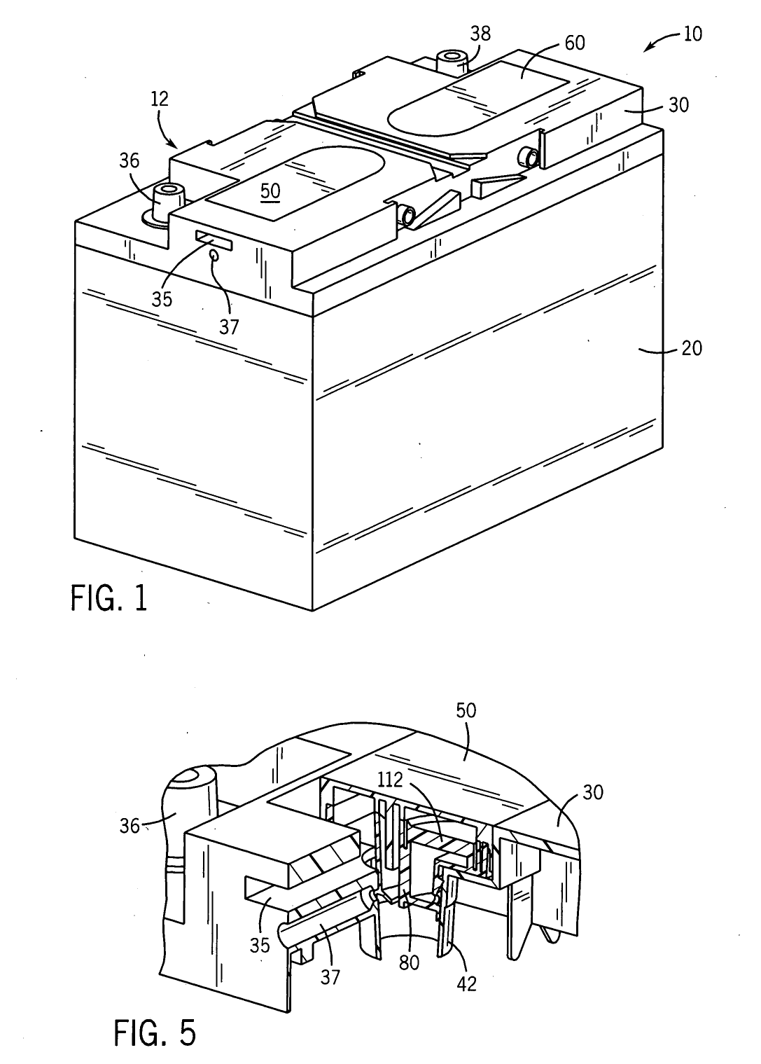

As shown in FIG. 1, a battery 10 (e.g., a lead-acid battery for use with vehicles or other applications, including starting, lighting, and ignition batteries; a commercial battery; an industrial battery; a marine battery; etc.) includes a housing 20 and a cover 30 coupled to housing 20 (i.e., by heat sealing the cover to the battery at various points). A venting system 12 is provided for venting gases from within battery 10.

As shown in FIG. 1, a plurality of terminals or bushings 36, 38 are provided on cover 30 for connecting or coupling battery 10 to electrical loads (e.g., a vehicle electrical system, etc.) according to an exemplary embodiment. While FIG. 1 shows terminals 36, 38 extending from a top surface of cover 30, it should be noted that according to other exemplary embodiments, terminals may be provided on a side of a battery in addition to or in place of terminals shown as terminals 36, 38 (e.g., for applications in which side terminal batteries are utilized).

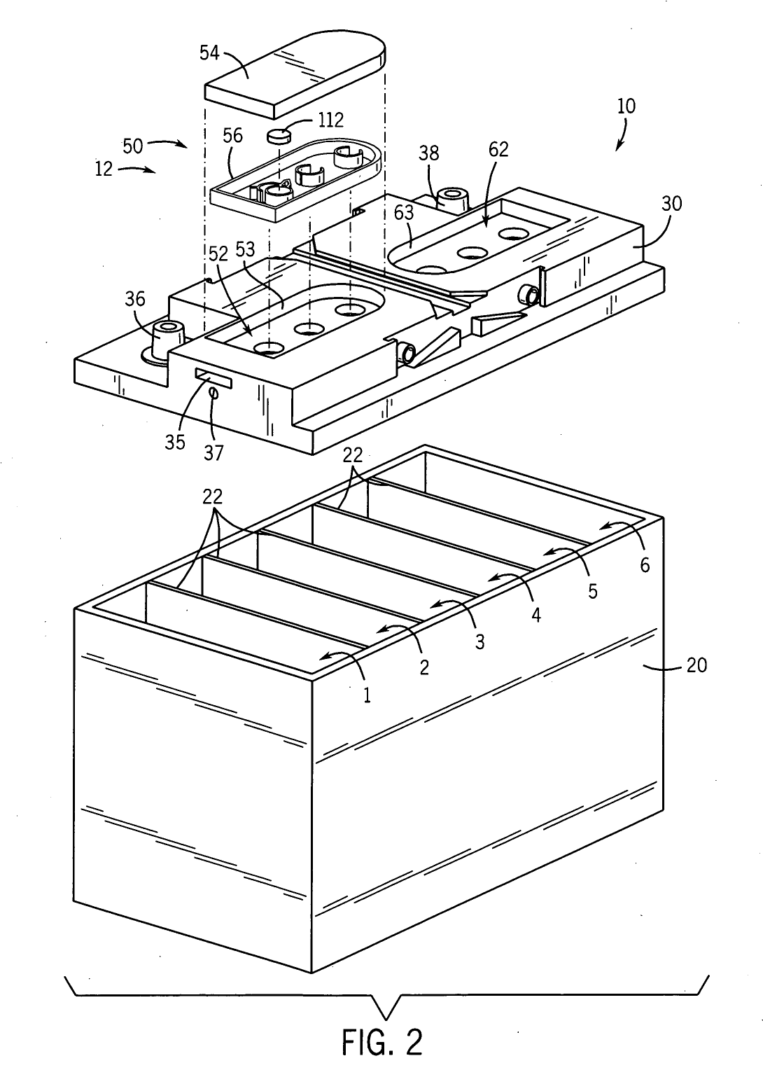

As shown in FIG. 2, housing 20 includes a plurality of cell walls or partitions 22 that define a plurality of cells 1, 2, 3, 4, 5, and 6 (e.g., chambers) according to an exemplary embodiment. While FIG. 2 shows housing 20 having six cells, according to other exemplary embodiments, a different number of cells may be provided (e.g., more than six cells, etc.). Further, while the cells are shown in FIG. 2 as having a generally rectangular shape, other shapes may be used for the cells (e.g., generally cylindrical, etc.) according to other exemplary embodiments.

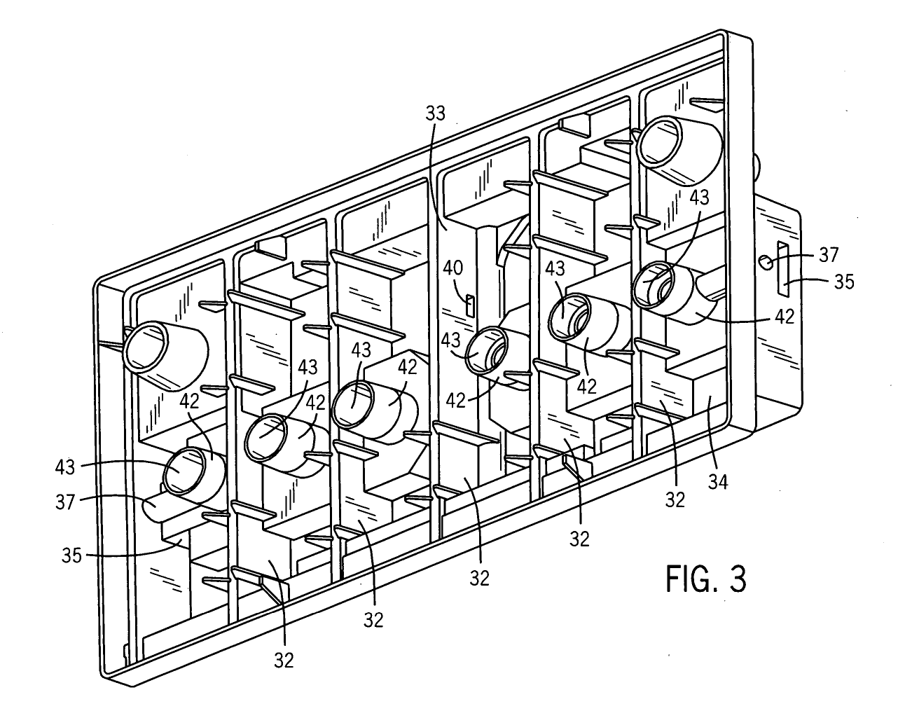

As shown in FIG. 3, cover 30 includes a number of walls or partitions 32 extending from a surface 34 of cover 30. Partitions 32 provided in cover 30 are provided such that they are aligned with partitions 22 provided in housing 20 when cover 30 is coupled to housing 20 to form the cells (i.e., the spaces defined by the partitions in the cover and in the housing may be referred to as cells). During a heat sealing operation in which cover 30 is secured to housing 20, partitions 32 are aligned with partitions 22 and sealed thereto. Accordingly, each of the cells of the battery are isolated from one another utilizing partitions provided in the cover and in the housing (e.g., partitions 32 and 22, respectively).

The cells may conventionally be referred to by number (e.g., a six-cell battery would have cells 1, 2, 3, 4, 5, and 6 as shown in FIG. 2). According to an exemplary embodiment in which battery 10 is provided as having six cells (e.g., cells 1, 2, 3, 4, 5, and 6 as shown in FIG. 2), five partitions are provided, one of which is provided between each of the six cells.

Cells 3 and 4 in a flat plate type battery such as that shown in FIG. 2 correspond to the two cells closest to the middle or center of battery 10. The partition separating cells 3 and 4 may be referred to as the center partition. The center partition in cover 30 (labeled with reference numeral 33 in FIG. 3) includes an aperture 40 (e.g., an opening, hole, void, cutout, channel, etc.) formed therein. Aperture 40 allows for gas flow between cells 3 and 4 of battery 10 across center partition 33. According to an exemplary embodiment, aperture 40 is provided toward the top of center partition 33 (e.g., toward surface 34 of cover 30, which is near the top of battery 10 when cover 30 is provided on housing 20). According to an exemplary embodiment, aperture 40 is formed above the heat seal which joins cover 30 to housing 20.

The size, shape, and configuration of aperture 40 may vary according to any of the number of considerations. According to an exemplary embodiment as shown in FIG. 3, aperture 40 has a relatively rectangular shape. According to various other exemplary embodiments, the aperture may have another shape (e.g., circular, oval, square, etc.). Further, while aperture 40 is shown in FIG. 3 as being provided in center partition 33, apertures may also be provided in other partitions of cover 30 in addition to aperture 40 provided in center partition 33.

According to an exemplary embodiment, battery 10 includes two members or elements 50, 60 (e.g., shown as gang vents) configured to provide gas communication (e.g., a path for gas to travel) between three adjacent cells. Gang vents 50, 60 may be provided such that three adjacent cells communicate gas therebetween (e.g., cells 1, 2, and 3 shown in FIG. 2 are in gas communication with each other by virtue of gang vent 50). According to other exemplary embodiments, a different number of gang vents may be provided. According to other exemplary embodiments, the one or more gang vents may provide gas communication between a different number of cells (e.g., two cells, four cells, etc.).

To provide gas communication between gang vent 50 and gang vent 60, aperture 40 provides for gas communication between two adjacent cells (e.g., cells 3 and 4 as shown in FIG. 2), each of which is provided with a separate gang vent (e.g., cell 3 is in gas communication with gang vent 50 and cell four is in gas communication with gang vent 60). Accordingly, gas may travel freely between gang vents 50 and 60.

In a fully assembled battery, each of cells 1-6 includes a cell element (not shown) that includes one or more positive electrodes, one or more negative electrodes, and at least one separator provided intermediate or between the positive and the negative electrodes. According to an exemplary embodiment, each of cells 1-6 includes a plurality of positive and negative electrodes (e.g., a plurality of flat plate style electrodes). According to another exemplary embodiment, each of the cells includes a single positive electrode and a single negative electrode (e.g., a spiral wound electrode configuration). Other configurations may be utilized according to other exemplary embodiments.

As shown in FIG. 3, cover 30 includes a plurality of members or elements 42 (shown in the form of cover barrels) that are generally tubular or cylindrical in shape. Cover barrels 42 may also be referred to as cover vent barrels or cylinders, as cover splash barrels, and/or as vent members.

According to an exemplary embodiment, cover barrels 42 have a tapered shape which narrows from surface 34 of cover 30 toward housing 20 when cover 30 is installed on housing 20. According to various other exemplary embodiments, the cover barrels may have different sizes, shapes, and/or configurations.

Cover barrels 42 extend downward from cover 30 toward cells 1-6 provided in housing 20 according to an exemplary embodiment. Cover barrels 42 define openings or apertures 43 through which liquid electrolyte may be introduced into cells 1-6 and through which gas may be expelled from cells 1-6. According to an exemplary embodiment, one cover barrel 42 is provided for each of cells 1-6 of battery 10. According to other exemplary embodiments, a different number of cover barrels may be provided.

As shown in FIG. 2, cover 30 includes one or more cutouts or openings 52, 62 (e.g., recessed wells) configured to receive therein gang vents 50, 60. Cutouts 52, 62 include apertures 43 (as shown in FIG. 3) defined at least in part by cover barrels 42 extending toward cells 1-6. Apertures 43 provide a port or passage through which electrolyte (e.g., acid) may be introduced into battery 10 and through which gas may be vented or expelled from cells 1-6. Subsequent to the battery filling operation, gang vents 50, 60 may be installed in cutouts 52, 62 to seal cells 1-6.

According to an exemplary embodiment, cutouts 52, 62 have a size, shape, and/or configuration such that gang vents 50, 60 provided therein must be inserted in a particular manner. For example, as shown in FIGS. 1-2, one end of cutout 52 is relatively straight while the opposite end of cutout 52 is generally curved. In such an exemplary embodiment, gang vent 50 that includes a relatively straight side and a relatively curved side must be inserted in cutout 52 such that the curved portion of gang vent 50 and cutout 52 are aligned and the straight side of gang vent 50 and cutout 52 are aligned. One advantageous feature of such an arrangement is that gang vents must be inserted in the proper orientation in order for the gang vent to be securely coupled to the battery. While the gang vents and cutouts are shown as having one curved side and one straight side, it should be noted that according to other exemplary embodiments, different configurations for the gang vents and cutouts may be utilized (e.g., instead of having a curved shape, one side of the gang vent may have a shape different from a curved shape, etc.).

Cutouts 52, 62 include walls 53, 63 that are angled or sloped according to an exemplary embodiment. For example, walls 53, 63 may taper outward such that the size of the opening at the bottom of the cutout is smaller than the size of the opening at the top of the cutout. In such a configuration, walls 53, 63 may be configured to abut complementary walls provided in a gang vent (e.g., gang vents 50, 60). For example, where the walls of the cutout taper outward from the bottom of the cutout toward the top of the cutout, the walls of the gang vent may taper inward from a top surface of a gang vent toward the bottom surface of a gang vent.

Cover barrels 42 are provided within cutouts 52, 62 such that they extend from a bottom of cutouts 52, 62 toward the cells (e.g., cells 1-6) of battery 10.

As shown in FIG. 1, according to an exemplary embodiment at least one drain 35 (e.g., a process drain) in the form of an aperture or channel (e.g., a passage, conduit, etc.) is provided in cover 30 through which excess or retained electrolyte (e.g., sulfuric acid) or liquid (e.g., wash water) may be expelled (e.g., during battery processing). According to an exemplary embodiment shown in FIG. 1, drain 35 has a relatively rectangular cross-sectional shape. According to various other exemplary embodiments, the size, shape, and/or configuration of the drain may differ. According to an exemplary embodiment, more than one drain may be provided in the cover (e.g., as shown in FIG. 3, two drains may be provided at opposite ends of cover 30 or may be provided in other locations according to other exemplary embodiments).

According to an exemplary embodiment, at least one opening or aperture 37 (e.g., an exhaust port) is provided in cover 30 for expelling or exhausting gases from the interior of battery 10. As shown in FIG. 3, according to an exemplary embodiment, two exhaust ports 37 are provided in cover 30. According to various other exemplary embodiments, a different number of exhaust ports may be provided (e.g., one exhaust port, etc.).

According to an exemplary embodiment, plugs or seals (not shown) may be provided for capping or sealing one or more of the drain(s) 35 and/or exhaust port(s) 37. For example, a plug made from an elastomeric or other flexible or resilient material may be provided that has a size and shape configured for insertion into at least a portion of an exhaust port to prevent liquid or gas from entering the battery through the exhaust port or from escaping the battery through the exhaust port. According to another exemplary embodiment an exhaust port may be molded shut to prevent the escape of gas through such port.

Providing a plug or cap for one or more of the exhaust ports 37 may allow the exhaustion or expiration of gases from the interior of battery 10 through a single exhaust port 37. For example, according to an exemplary embodiment in which two exhaust ports are provided for a cover, one of the exhaust ports may be blocked such that gas flows through only one of the exhaust ports (i.e., the exhaust port not covered by the plug or cap). The process of expelling gas from a single exhaust port is referred to herein as single point or single port venting.

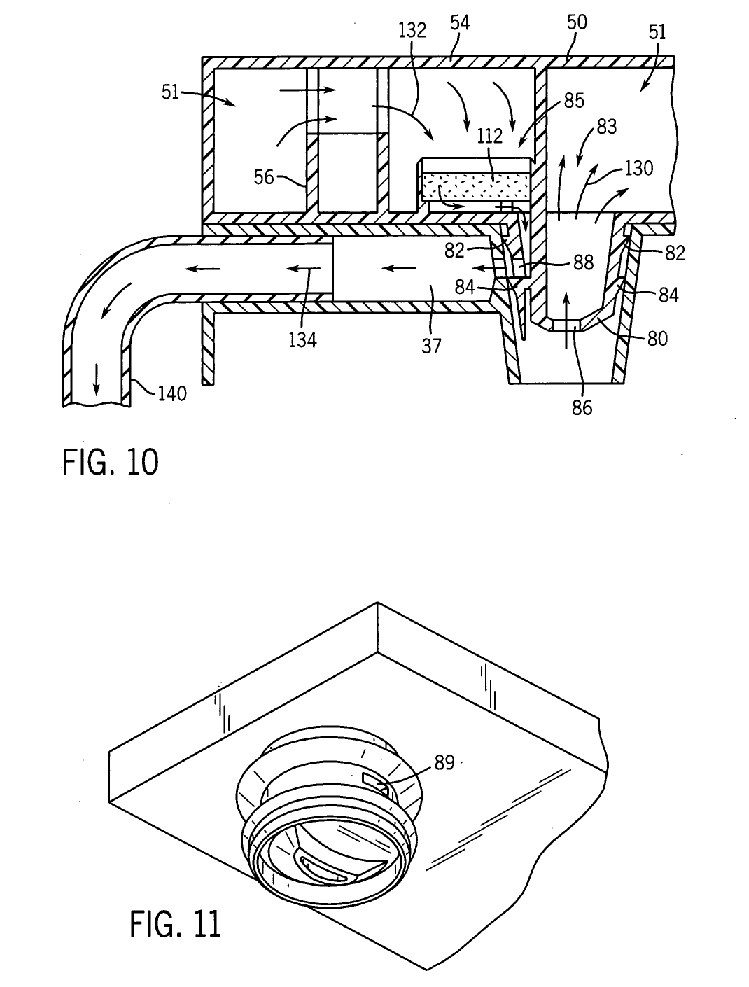

According to an exemplary embodiment, a tube or hose (shown, e.g., as tube 140 in FIG. 10) may be coupled to an exhaust port (e.g., exhaust port 37) for venting gases to a particular point. For example, a tube or hose may be provided for directing gases expelled from a battery to the exterior of a vehicle (e.g., where the battery is used in a passenger or storage compartment of a vehicle).

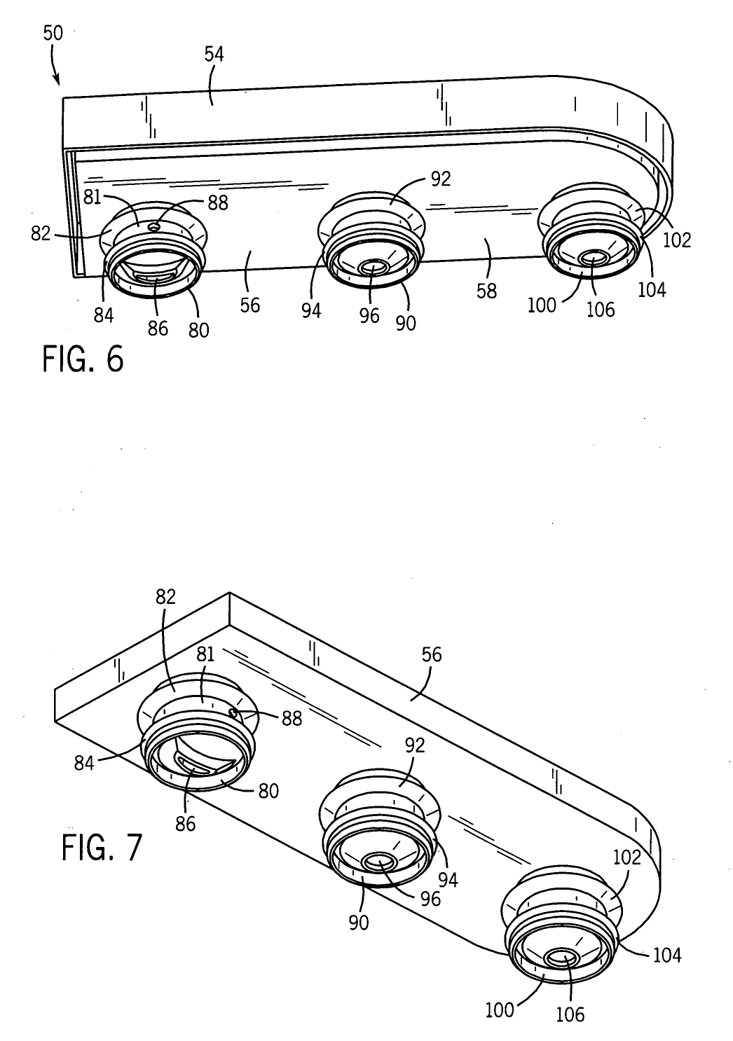

The gang vents (e.g., gang vents 50 and 60) include a top portion or cap and a bottom portion or member (e.g., a base). For example, as shown in FIGS. 6-9, gang vent 50 includes a top portion 54 and a bottom portion 56. It should be understood that features described with respect to gang vent 50 may also be included in gang vent 60 according to an exemplary embodiment. According to other exemplary embodiments, gang vent 60 may differ from gang vent 50 in one or more respects.

Top portion 54 of gang vent 50 is coupled to bottom portion 56 of gang vent 50 by heat sealing, adhesive, or other means. According to an exemplary embodiment, a portion of bottom portion 56 fits within at least a portion of top portion 54, as shown in FIG. 6 (e.g., bottom portion 56 at least partially nests in top portion 54).

As shown in FIG. 6, bottom portion 56 of gang vent 50 includes a plurality of elements or members 80, 90, and 100 (e.g., shown in the form of vent barrels) extending from a bottom surface 58 thereof. For ease of references, members 80, 90, and 100 will be referred to as vent barrels.

Each of vent barrels 80, 90, and 100 includes at least two seals (e.g., ring seals or flanges) on the exterior surface thereof. For example, vent barrel 80 includes seals 82 and 84, vent barrel 90 includes seals 92 and 94, and vent barrel 100 includes seals 102 and 104. According to an exemplary embodiment, each of the seals (e.g., seals 82, 84, 92, 94, 102, and 104) extends about the entire circumference of its respective vent barrel.

According to an exemplary embodiment, the seals (e.g., seals 82, 84, 92, 94, 102, and 104) are integrally formed with their respective vent barrels (e.g., vent barrels 80, 90, and 100). According to other exemplary embodiments, one or more of the seals may be produced separately and coupled or connected to a vent barrel.

According to an exemplary embodiment, each of the vent barrels (e.g., vent barrels 80, 90, and 100) includes an upper seal or flange and a lower seal or flange. Such an arrangement may be referred to as a double ring seal configuration. For example, seal 82 is an upper seal for vent barrel 80, while seal 84 is a lower seal for vent barrel 80. When gang vent 50 is coupled to cover 30, the lower seal prevents electrolyte from escaping from the battery cells and the upper seal prevents gas from reentering the cells along the outside of the vent barrel. According to another exemplary embodiment, one or more of the vent barrels includes only a single seal (e.g., a double ring seal configuration is not utilized).

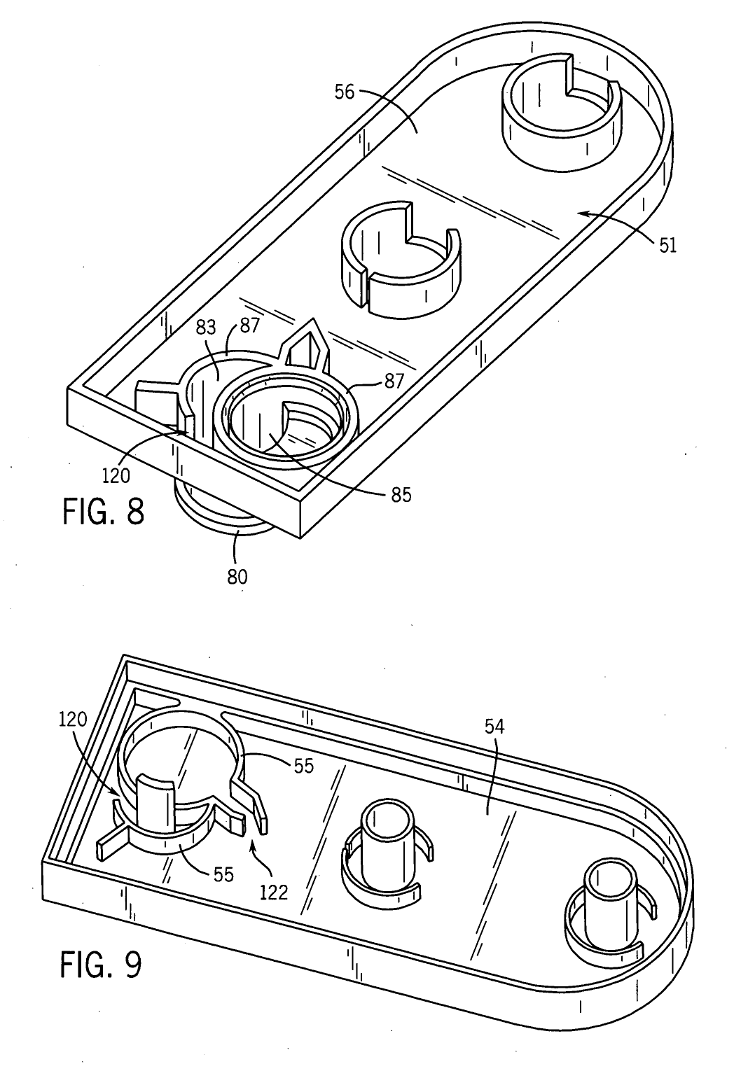

According to an exemplary embodiment, gang vent 50 is adapted to provide gas communication between the cells (e.g., cells 1-3) with which gang vent 50 communicates. For example, gas from each of cells 1-3 may be expelled into gang vent 50 through vent barrels 80, 90, and 100. As shown in FIG. 8, a space or void 51 is provided between top portion 54 and bottom portion 56 to allow gas to travel through gang vent 50.

According to an exemplary embodiment, each of the vent barrels includes an aperture or inlet through which gas may flow. For example, vent barrel 80 includes an aperture 86, vent barrel 90 includes an aperture 96, and vent barrel 100 includes an aperture 106. Apertures 86, 96, and 106 advantageously allow gas communication between gang vent 50 and cells (e.g., cells 1-3) of battery 10. The size, shape, and/or configuration of apertures 86, 96, and 106 may vary according to various exemplary embodiments. As shown in FIG. 7, two of the apertures (apertures 96 and 106) have a generally circular shape and another of the apertures (aperture 86) has a semi-circular or crescent-moon shape.

According to an exemplary embodiment, one of the vent barrels is provided with a second aperture or opening through which gases from the gang vent may be expelled from the battery. For example, as shown in FIG. 6, vent barrel 80 includes an aperture or outlet 88 provided through a side surface or side wall 81 thereof. In this manner, vent barrel 80 is provided as a dual function vent barrel (e.g., vent barrel 80 may both act as an inlet to provide a path for gas to enter gang vent 50 from a cell (e.g., cell 1) of battery 10 and also to act as an outlet to provide a path for gas to exit gang vent 50 to an exterior surface of battery 10, as will be described in greater detail below.

As shown in FIG. 6, aperture 88 is provided in the form of a circular opening in side wall 81 of vent barrel 80 intermediate or between the two seals (e.g., seals 82 and 84). According to other exemplary embodiments, the aperture provided in the side wall of the vent barrel may have a different size, shape, and/or configuration (e.g., a rectangular shape, etc.). For example, as shown in FIG. 11, an aperture 89 provided in a vent barrel is shown as having a generally rectangular shape.

According to an exemplary embodiment, vent barrel 80 is divided internally into two regions or chambers (e.g., passages). A first region or chamber 83 is configured to act as an inlet for allowing gas to flow from cell 1 to gang vent 50 (e.g., through aperture 86). A second region or chamber 85 is configured to act as an outlet for expelling gases from gang vent 50 to exhaust port 37 and hence out of battery 10. According to an exemplary embodiment, vent barrel 80 is configured to allow a single vent barrel of the same size as other vent barrels (e.g., vent barrels 90 and 100) provided in gang vent 50 to serve two functions—receiving gas into gang vent 50 a battery cell (e.g., cell 1) and transmitting gas from gang vent 50 to exhaust port 37.

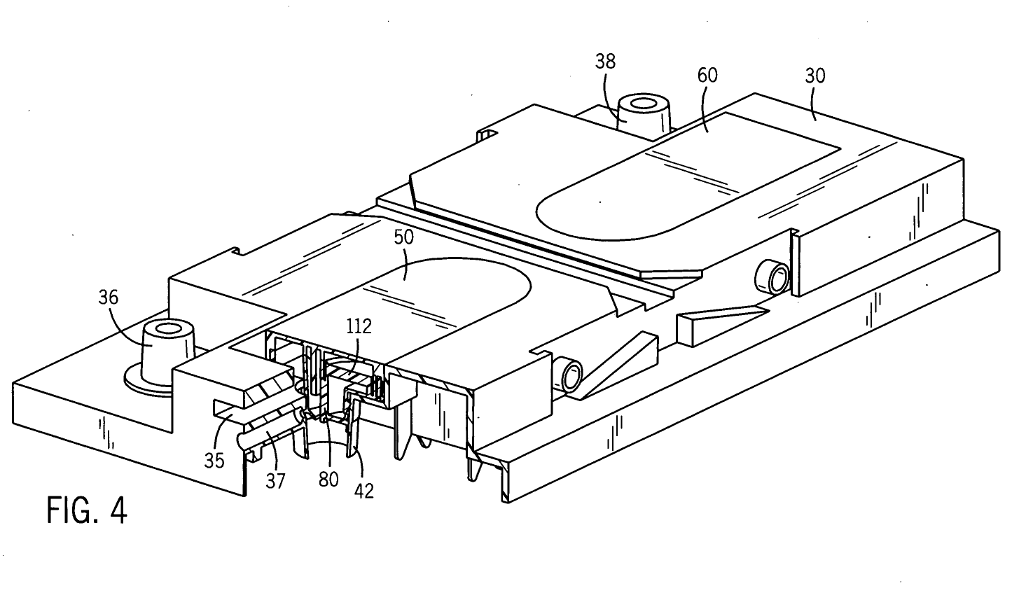

According to an exemplary embodiment, chamber 85 is provided such that a flame arrestor or frit 112 may be provided therein (FIGS. 2, 4, and 5). Gas traveling from gang vent 50 to exhaust port 37 through aperture 88 must first pass through flame arrestor 112. The size, shape, composition, and configuration of the flame arrestor may vary according to a variety of exemplary embodiments.

Aperture 88 in vent barrel 80 is provided intermediate or between seals 82 and 84 provided on side wall 81 of vent barrel 80 so that gas may travel around vent barrel 80 between seals 82 and 84 until it exits through aperture 88 and exhaust port 37. According to an exemplary embodiment, aperture 88 and exhaust port 37 are not in direct alignment with each other (see, e.g., FIGS. 5 and 7 for the relative orientation of aperture 88 and exhaust port 37); in such an embodiment, gas must travel around vent barrel 80 to the entry of exhaust port 37 so that it may be expelled through exhaust port 37. According to other exemplary embodiments, the aperture and the exhaust port may be aligned such that the gas may flow directly from the aperture to the exhaust port.

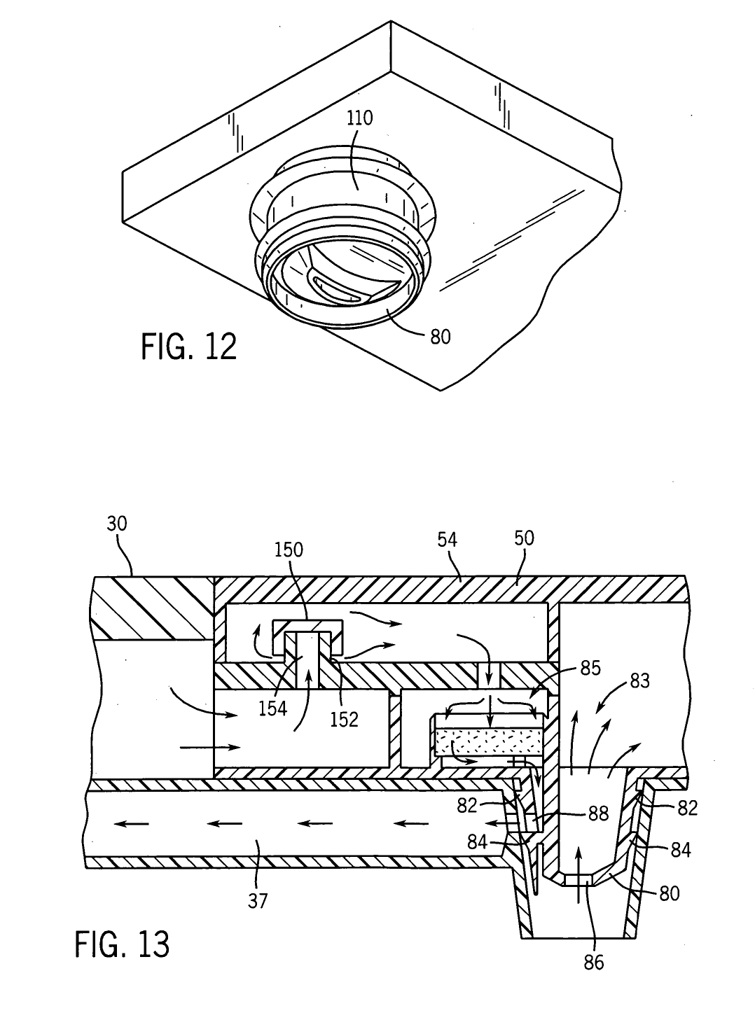

According to an exemplary embodiment (as shown, e.g., in FIG. 12), a valve 110 in the form of an elastomeric or other flexible or resiliently flexible material (e.g., a band of material) may be provided around vent barrel 80 such that aperture 88 provided in vent barrel 80 is covered until sufficient pressure builds up inside battery 10 and/or gang vent 50. When such pressure exceeds a predetermined threshold, valve 110 flexes or bends outward to allow expiration of gases from battery 10 until the pressure returns to below the predetermined threshold.

According to another exemplary embodiment, a Bunsen valve may be used within gang vent 50 in place of a valve such as valve 110 provided on an external surface of vent barrel 80. Such configurations may be utilized to accommodate sealed absorptive glass mat (AGM) battery recombination requirements. For example, as shown in FIG. 13, a cross-sectional view of a portion of a gang vent 50 (note that similar portions of the gang vent shown in FIG. 13 are labeled with the same reference numerals as were used in FIGS. 1-12) is shown in which a Bunsen valve 150 is provided on a structure 152 having an aperture 154 formed therethrough. Gas entering chamber 85 (and subsequently exiting vent barrel 80 through aperture 88) must first exceed a threshold pressure that causes Bunsen valve 150 to flex outward from structure or member 152 to allow gas to enter chamber 85. In this manner, the device for exhausting gas when it has exceeded a threshold pressure value is provided internal to the gang vent, as opposed to being provided on an external surface of a vent barrel as shown in FIG. 12.

As shown in FIGS. 8-9, top portion 54 and bottom portion 56 of gang vent 50 may include interior walls or partitions that provide a relatively circuitous or tortuous (e.g., labyrinthine) path for gas to travel from opening 86 of vent barrel 80 to chamber 85 of vent barrel 80 and eventually out of vent barrel 80 through exhaust port 88. For example, top portion 54 of gang vent 50 includes walls or partitions 55 and bottom portion 56 of gang vent 50 includes walls or partitions 87.

According to an exemplary embodiment shown in FIGS. 8-9, walls 55 provided in top portion 54 of gang vent 50 align with walls 87 provided in bottom portion 56 of gang vent 50 when top portion 54 and bottom portion 56 are assembled. Openings or passages 120, 122 in walls 55, 87 provide a path for gas to travel. For example, gas entering the gang vent through opening 86 travels into first chamber 83, travels around walls 55 and 87 through opening 120 to space 51 in gang vent 50 (i.e., the space between top portion 54 and bottom portion 56 of gang vent 50), and enters second chamber 85 through opening 122. The details shown for the walls 55, 87 shown in FIGS. 8-9 are exemplary only, and any of a variety of methods of providing a path for gas to travel from the inlet to the outlet of the vent barrel may be provided.

FIG. 10 illustrates the general flow of gas within a gang vent similar to that shown as gang vent 50 in FIG. 1. As shown in FIG. 10, gas enters vent barrel 80 along a first path 130 through aperture 86 provided therein such that the gas flows into chamber 83 of vent barrel 80 and into space 51 in gang vent 50. Gas then travels into chamber 85 of vent barrel 80 along a second path 112, after which it travels through flame arrestor 112, and through aperture 88 of vent barrel 80 into exhaust port 37 along a third path 134 (out of battery through a tube or hose 140 connected to exhaust port 37).

One advantageous feature of providing an indirect route for gas to travel from vent barrel 80 to exhaust port 37 (and from first chamber 83 to second chamber 85 of vent barrel 80) is that such a configuration ensures that all gas expelled from battery 80 first travels through flame arrestor 112 before exiting battery 10.

When one of the exhaust ports (e.g., such as exhaust port 37) are blocked or capped to provide a single port venting configuration, the aperture in the vent barrel adjacent the blocked exhaust port is also effectively blocked (i.e., gas will not escape the battery through the aperture). Because gang Vents 50, 60 are in gas communication with each other through aperture 40 provided in cover 30, gas may exit battery 10 through a single exhaust port 37.

According to an exemplary embodiment, each of gang vents 50, 60 have an identical configuration. For example, each of the gang vents includes one vent port is a dual function vent barrel. The cutouts in the cover (e.g., cutouts 52, 62) may be configured such that gang vents 50, 60 are rotated 180° with respect to each other, such that the dual function vent barrels (e.g., vent barrel 80) are provided adjacent external cells of the battery (e.g., these cover barrels are provided at the two outermost cells).

One advantageous feature of providing identical gang vents is that such gang vents may be produced relatively efficiently, since only a single type of gang vent must be provided (e.g., resulting in lower warehouse storage costs, lower tooling expense, etc.). According to other exemplary embodiments, the gang vents may have different configurations. For example, only one of the gang vents may have a vent barrel that has dual inlet/outlet functionality to allow for expulsion of gases from the battery.

Various other features may be provided in the venting system. For example, one or more of the vent barrels may include a locking mechanism for securing the vent barrels within the cover barrels of the cover. According to such an embodiment, the vent barrel may include a feature (e.g., a lip, flange, etc.) that engages a feature provided in the cover barrel (e.g., a lower edge of the cover barrel) to secure the vent barrel in place. This may be a one-way locking mechanism in which a portion of the vent barrel flexes inward until it reaches the point of engagement, at which point the vent barrel flexes outward to engage the feature of the cover barrel.

While the embodiments shown in the FIGURES show gang vents having a vent barrel that serves both as an inlet from a cell and as an outlet for gases retained within the gang vent, according to another exemplary embodiment (not shown), separate members may be provided for each function. That is, each gang vent may have three inlets in the form of cover barrels and another member to allow for expiration of the gases from the gang vent (e.g., an aperture, cylinder having an aperture therein, etc.). One advantageous feature of providing a dual-function vent barrel is that material and manufacturing costs may be reduced.

According to an exemplary embodiment, gang vents 50, 60 and the various components thereof comprise a polymeric material such as polypropylene. According to another exemplary embodiment, the gang vents (or portions thereof) may comprise between approximately 25 and 50% elastomeric material (e.g., rubber) to provide for added flexibility of the components.

According to an exemplary embodiment, the various components of gang vents 50, 60 are separately formed (e.g., a top portion may be molded separately from a bottom portion to allow insertion of a flame arrestor in the outlet). Any of a variety of manufacturing operations may be utilized.

According to an exemplary embodiment, gang vents 50, 60 are coupled to battery 10 by means of a heat seal, adhesive, snap-fit, or other fastening mechanism. The particular fastening mechanism chosen may depend on a variety of factors, including manufacturability, cost, efficiency, and/or others.

According to an exemplary embodiment in which a valve (e.g., a ring valve about the outside of a vent barrel, a Bunsen valve, etc.) is utilized (e.g., for recombination AGM lead-acid batteries), the valve may be an elastomeric material such as synthetic rubber or the like. According to an exemplary embodiment, an EPDM material may be utilized. One advantageous feature of utilizing an EPDM material is that the material is relatively resistant to degradation due to contact with acid (e.g., sulfuric acid).

According to an exemplary embodiment, a venting system 12 for battery 10 is provided in which single point or single port venting of gases may be achieved. That is, gases expelled or exhausted from the battery may travel through a single exhaust or exit port. According to other exemplary embodiments, multiple-port venting may be provided by venting system 12.

According to an exemplary embodiment, a plurality (e.g., two or more) of gang vents (e.g., gang vents 50, 60), each including a plurality of vent barrels (e.g., vent barrels 80, 90, and 100) extending therefrom, are provided in a battery cover 30. Each of vent barrels 80, 90, 100 is configured to provide a passage for gas to travel from the cells (e.g., cells 1-3) of battery 10 to a space between a top portion and a bottom portion of the gang vents. According to an exemplary embodiment, each of the gang vents includes three vent barrels extending therefrom. According to other exemplary embodiments, a different number of vent barrels may be provided on each of the gang vents.

According to an exemplary embodiment, gas may flow between adjacent gang vents by virtue of an aperture formed in a partition wall of the battery cover (e.g., in the area above the interface between the cover and the battery housing, such as a heat seal). The aperture may have any of a variety of sizes, shapes, and/or configurations. The aperture enables communication of gas between adjacent cells of the battery. For example, where a first gang vent provides for gas communication with a first cell of the battery and a second gang vent provides for gas communication with a second cell of the battery that is adjacent to the first cell, the gang vents may communicate gas between themselves through the aperture provided in the partition between the cells.

Each of the vent barrels provided on the gang vents have at least one seal or flange (e.g., ring seal) provided about the outer or exterior surface of the vent barrel. The seal may be utilized to prevent gas and/or liquid (e.g., electrolyte) communication between the cover and the battery cell about the outside of the vent barrel. At least one of the vent barrels includes two seals on the outside of the vent barrel. In such a configuration, a lower seal prevents gas electrolyte from escaping the battery to the cover around the vent barrel and an upper seal prevents exhaust gas from bypassing the exhaust post by escaping past the vent barrel. According to an exemplary embodiment, each of the vent barrels provided on the gang vents includes a double ring seal configuration.

According to an exemplary embodiment, at least one of the gang vents includes a vent barrel or cylinder that has dual functionality. That is, the vent barrel includes an inlet for allowing gas to be expelled into the gang vent from a battery cell and also includes an outlet through which gas in the gang vent may be expelled from the battery through an aperture provided in the vent barrel. A flame arrestor may be provided in the gang vent in the path of the gas exiting the battery (e.g., in the outlet). According to an exemplary embodiment, the vent barrel has an external size and shape similar or identical to the other cover barrels provided in the gang vent so that it may be inserted within a standard size aperture provided in the battery cover. The size, shape, and/or configuration of the dual-function vent barrel may vary according to various exemplary embodiments. For example, the shape of the aperture configured to allow expulsion of the gases from the gang vent may be circular, rectangular, or another shape.

As will be appreciated by those of skill in the art, one advantageous feature of providing a dual-function vent barrel is that gases from a battery cell may be exhausted from the cell into the gang vent, and that gas may also be exhausted from the battery using the same vent barrel (e.g., through the aperture provided in the vent barrel). A relatively indirect path may be provided using one or more walls or partitions in the gang vent to ensure that gas from the cell travels through a flame arrestor prior to being vented from the battery.

An aperture is provided in the vent barrel intermediate or between the seals on the exterior surface of the vent barrel. Gas from the gang vent travels through a flame arrestor provided in the gang vent and through the aperture by way of an outlet. The gas exiting the aperture is constrained within a channel or passage between the ring seals, the vent barrel, and the cover barrel of the cover. An outlet or exhaust port in the cover is provided that forms a passageway through which the gas may be exhausted from the battery. According to an exemplary embodiment, the aperture is not directly in line with the exhaust port, and the gas must therefore travel around at least a portion of the vent barrel before the gas may escape the cover through the exhaust port.

According to an exemplary embodiment, two gang vents having substantially identical configurations are provided in the battery cover. The battery cover has two exhaust ports, one of which may be sealed by a seal or plug to prevent the escape of gas through this exhaust port (e.g., such that gas escapes only through a single exhaust port to provide single-point venting for the battery). Gas expelled during formation or operation of the battery travels from the cells to the gang vents by way of the cover barrels. Gas included in the gang vent that is adjacent to the sealed or plugged exhaust port travels through an aperture provided in a partition provided in the cover and into the adjacent gang vent. Gas in the gang vent for which the exhaust port is not blocked or sealed is exhausted or expelled from the cover by traveling through the flame arrestor, out the aperture provided in the dual-function vent barrel, and out of the cover by way of the exhaust port. In this manner, gas expelled from the battery is vented from a single exhaust port. That is, one of the gang vents acts as a manifold to transfer gas to another gang vent, which acts to exhaust the gas from the battery. Such a configuration is intended to provide compliance with certain DIN and EN standards which require that gas from a battery be vented off of the ends of the battery cover. Certain original equipment (OE) manufacturers may require that one of these end exhaust ports be plugged or molded shut to provide single point venting. In applications where single point venting is not required, both ports may be used to exhaust gases.

One or more valves (e.g., Bunsen valves, ring valves, etc.) may be provided for ensuring that gas is exhausted from the battery only when the internal pressure of the battery exceeds a predetermined threshold. The valve may be provided within the gang vent or cover or may be provided over the aperture in the vent barrel through which gas is expelled from the battery. Such valves may be used for proper function of recombination lead-acid AGM batteries.

Various advantages may be obtained using a venting system such as that shown and described herein. For example, such a venting system may provide a single pathway for venting or exhausting gases from a battery (e.g., by utilizing a single exhaust port (e.g., channel, hole, aperture, passage, etc.) for venting or exhausting gases from the battery). Another advantage is that at least one gang vent (i.e., an element or member that includes a plurality of cover barrels or cylinders for extending toward a cell of a battery and through which gas may exit the cells) provided in the venting system may include an element or member in the form of a vent barrel or cylinder that includes both an inlet for gas to enter the gang vent and an outlet to enable expulsion of gases from the gang vent (e.g., the vent barrel may have “dual-functionality”). The venting system may utilize an element or member such as a vent barrel or cylinder that includes both a gas inlet and a gas outlet and that includes structures such as walls or members that provide a relatively indirect (e.g., circuitous, tortuous, labyrinthine, etc.) path for gas to flow from the inlet to the outlet.

It is important to note that the construction and arrangement of the elements of the venting system as shown in the various exemplary embodiments is illustrative only. Although only a few embodiments of the present inventions have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited herein. For example, elements shown as integrally formed may be constructed of multiple parts or elements (e.g., seals provided on cover barrels may be integrally formed or manufactured as separate components and coupled to the cover barrels), the position of elements may be reversed or otherwise varied (e.g., the vent barrel serving both an inlet and an outlet function may be near the center of the battery rather than toward the outer cells of the battery), and the nature or number of discrete elements or positions may be altered or varied (e.g., a different number of gang vents and/or cover barrels may be provided based on a variety of factors, including the number of cells in the battery). It should be noted that the elements and/or assemblies of the system may be constructed from any of a wide variety of materials that provide sufficient strength or durability, including any of a wide variety of moldable plastic materials (such as high-impact plastic) in any of a wide variety of colors, textures and combinations. Other substitutions, modifications, changes and omissions may be made in the design, operating conditions and arrangement of the preferred and other exemplary embodiments without departing from the scope of the present inventions.

1. A venting system for a battery having a plurality of cells comprising:
a member configured for gas communication with a plurality of the cells, the member comprising a plurality of vent barrels;
wherein at least one of the vent barrels comprises a first aperture and a second aperture;
wherein the first aperture is configured to provide an opening through which gas may enter the member; and
wherein the second aperture is configured to provide an opening through which gas may exit the member.

2. The venting system of claim 1 wherein the at least one vent barrel comprises a plurality of seals and the second aperture is provided between the seals.

3. The venting system of claim 2 wherein the seals are provided on an exterior surface of the at least one vent barrel.

4. The venting system of claim 1 wherein the at least one vent barrel is internally divided into a plurality of chambers such that a first chamber comprises the first aperture and a second chamber comprises the second aperture.

5. The venting system of claim 1 wherein the member comprises a flame arrestor.

6. The venting system of claim 1 wherein the member comprises a top portion and a bottom portion, at least one of the top portion and the bottom portion comprising at least one partition configured to provide a path for gas to travel from the first aperture to the second aperture.

7. The venting system of claim 1 wherein the member comprises three vent barrels.

8. A lead-acid battery having a plurality of cells provided in a container comprising:
a cover coupled to the container;
at least one gang vent coupled to the cover and in gas communication with a plurality of the cells; and
a plurality of vent barrels extending from the at least one gang vent;
wherein at least one of the vent barrels comprises an inlet configured to provide a path for gas to travel from at least one cell of the battery into the gang vent and an outlet configured to provide a path for gas to be expelled from the gang vent.

9. The lead-acid battery of claim 8 wherein the inlet comprises an aperture provided at a bottom of the at least one vent barrel and the outlet is provided in a side of the at least one vent barrel.

10. The lead-acid battery of claim 9 wherein the at least one vent barrel comprises a plurality of ring seals provided on the side of the at least one vent barrel.

11. The lead-acid battery of claim 10 wherein the aperture provided on the side of the at least one vent barrel is provided intermediate the ring seals.

12. The lead-acid battery of claim 8 further comprising a valve for controlling the flow of gas from the gang vent.

13. The lead-acid battery of claim 8 further comprising a flame arrestor provided in the at least one gang vent.

14. The lead-acid battery of claim 8 wherein the gang vent comprises a structure for providing a path between the inlet and the outlet.

15. The lead-acid battery of claim 14 wherein the structure comprises at least one wall provided in the gang vent for providing a path for gas to enter the gang vent from the inlet and for providing a path for gas to exit the gang vent through the outlet.

16. The lead-acid battery of claim 8 further comprising a port provided in the cover for directing gas from the gang vent to a location external to the battery.

17. The lead-acid battery of claim 8 wherein the battery comprises two gang vents in gas communication with each other.

18. A cover for a lead-acid battery comprising:
a plurality of gang vents, each of the plurality of gang vents configured for gas communication with a plurality of cells of a battery, each of the plurality of gang vents being provided in gas communication with at least one other gang vent; and
an exhaust port provided in the cover that is in gas communication with at least one of the gang vents to allow gas to escape from the gang vents;
wherein at least one of the gang vents includes at least one vent barrel that includes both an inlet for allowing gas to enter the at least one gang vent from a battery cell and an outlet for allowing gas to escape the at least one gang vent through the exhaust port.

19. The lead-acid battery of claim 18 wherein the inlet comprises a first aperture and the outlet comprises a second aperture, wherein the second aperture is not directly aligned with the exhaust port.

20. The lead-acid battery of claim 18 wherein the second aperture is provided between a first seal and a second seal provided on an exterior surface of the at least one vent barrel.
